(19) United States
(12) Patent Application Publication
(10) Pub. No.: US 2022/0340786 A1
(43) Pub. Date: Oct. 27, 2022

(54) ADHESIVE COMPOSITIONS

(71) Applicant: LION COPOLYMER GEISMAR, LLC, Geismar, LA (US)

(72) Inventors: Xianjie (Tony) REN, Geismar, LA (US); John D. Jacquin, Geismar, LA (US); Qiang Luo, Geismar, LA (US); Gregory J. Brust, Geismar, LA (US)

(73) Assignee: LION COPOLYMER GEISMAR, LLC, Geismar, LA (US)

(21) Appl. No.: 17/730,634

(22) Filed: Apr. 27, 2022

Related U.S. Application Data
(60) Provisional application No. 63/180,134, filed on Apr. 27, 2021.

(51) Int. Cl. C09J 7/38; C09J 7/10; C09J 11/08

(52) U.S. Cl. CPC C09J 7/383; C09J 7/10; C09J 11/08; C09J 2301/302; C09J 2301/414; C09J 2301/408; C09J 2415/00; C09J 2493/00; C09J 2433/00; C09J 2491/00; C09J 2423/00

(57) ABSTRACT

Disclosed herein are pressure sensitive adhesive compositions that can include a styrene-butadiene rubber latex and a tackifier agent. In another example, the pressure sensitive adhesive compositions can include a styrene-butadiene rubber latex and acrylic polymer. The adhesive compositions can further include mineral oil and ethylene propylene diene monomer rubber. The pressure sensitive adhesives compositions can have a have low volatile organic compound vapor pressures while having effective adhesion properties on low surface energy substrates.

### CROSS-REFERENCE TO RELATED APPLICATIONS

This application claims benefit of priority under 35 U.S.C. § 119(e) of U.S. Serial No. 63/180,134, filed Apr. 27, 2021, the entire contents of which is incorporated herein by reference in its entirety.

### BACKGROUND

### Field

Disclosed herein are pressure sensitive adhesives compositions. The pressure sensitive adhesives compositions can include a styrene-butadiene rubber and a tackifying resin or acrylic polymer.

### Description of the Related Art

Adhesives and particularly pressure sensitive adhesives (PSA) are in global demand. However, most adhesives on the market contain large amounts of volatile organic compounds (VOC)s which are organic chemicals that have a high vapor pressures at room temperatures. According to the Environmental Protection Agency, VOCs are emitted as gases from certain solids or liquids and include a variety of chemicals, some of which may have short- and long-term adverse health effects. Glues and adhesives are well documented to contain VOCs.

Adhesives with low VOC are desired due to increased concerns about environment and health and resulting new VOC regulations. Although acrylic emulsion products are widely used as raw materials for adhesives with low VOC, the development of acrylic adhesives are restricted because they provide low adhesion properties on low surface energy substrates as observed in U.S. patent publication 2016/0108295A1. For example, typical acrylic emulsion products like FASSON® S7000, exhibit 1.4 lb/inch loop tack and 1.5 lb/inch peel strength on polypropylene, which are lower than the adhesives described herein.

The prior art shows pressure sensitive adhesives have limitations. For example, U.S. Pat. No. 8,623,972 shows solvent based pressure sensitive adhesives that have been widely used in the industry. But these adhesives contain high VOC content that will not meet new regulations. Moreover, the U.S. Pat. Nos. 4,189,419 and 4,508,864 disclose waterborne adhesives made by carboxylated styrene-butadiene rubber (SBR) which have low VOC and promising adhesion properties. However, the carboxylation increases additional cost of production precluding wide-spread use. Likewise, U.S. Pat. No. 4,189,419 requires a high tackifier loading about 100 phr (parts per hundred rubber), which also greatly increases costs.

Consequently, there is need for new adhesive compositions that have low volatile organic compound vapor pressures while having effective adhesion properties on low surface energy substrates.

### SUMMARY

Provided herein are pressure sensitive adhesives compositions. In a specific embodiment, the adhesive composition can include a styrene-butadiene rubber latex, where the styrene-butadiene latex is present in a concentration from about 60 wt % to about 70 wt %, based on the total weight of the adhesive composition; and a tackifier agent, where the tackifier agent is present in a concentration from about 30 wt % to about 40 wt %, based on the total weight of the adhesive composition.

In another specific embodiment, the adhesive composition can include a styrene-butadiene rubber latex, where the styrene-butadiene rubber latex is present in a concentration from about 20 wt % to about 80 wt %, based on the total weight of the adhesive composition; and an acrylic polymer, where the acrylic polymer is present in a concentration from about 20 wt % to about 80 wt %, based on the total weight of the adhesive composition.

In another specific embodiment, the adhesive composition can include a styrene-butadiene rubber latex, where the styrene-butadiene rubber latex is present in a concentration from about 60 wt % to about 70 wt %, based on the total weight of the adhesive composition; a tackifier agent, wherein the tackifier agent is present in a concentration from about 30 wt % to about latex 40 wt %, based on the total weight of the adhesive composition; and a naphthenic oil, where the naphthenic oil is present in a concentration from about 1 wt % to about 10 wt %, based on the total weight of the adhesive composition, where the adhesive composition has a loop tack from about 0.01 lb/in to about 3.0 lb/in conducted according to ASTM D6195, and wherein the adhesive composition has a lap shear from about 1 psi to about 36 psi conducted according to ASTM D 1002.

### BRIEF DESCRIPTION OF THE DRAWINGS

The present disclosure can be better understood by referring to the following drawings. The drawings constitute a part of this specification and include exemplary embodiments of the adhesive compositions, which may be embodied in various forms.

FIG. 1 shows the experimental results of specified tackifiers with crosslinked and non-crosslinked latexes in Table 3.

FIG. 2 shows the experimental results for the use of mineral oil and ethylene propylene diene monomer rubber in Table 4.

### DETAILED DESCRIPTION

The adhesive compositions can include, but are not limited to, one or more styrene-butadiene rubbers, one or more tackifier agents, one or more acrylic polymers, one or more ethylene propylene diene monomer rubbers, one or more oils, one or more additives, and water. The adhesive compositions can be optionally absent of the one or more styrene-butadiene rubbers, one or more tackifier agents, one or more acrylic polymers, one or more ethylene propylene diene monomer rubbers, one or more oils, and water. For example, the adhesive compositions can include one or more styrene-butadiene rubber latexes and one or more tackifier agents. In another example, the adhesive compositions can include one or more styrene-butadiene rubbers and one or more tackifier agents. In another example, the adhesive compositions can include one or more styrene-butadiene rubber latexes and one or more acrylic polymers latexes. In another example, the adhesive compositions can include one or more styrene-butadiene rubbers and one or more acrylic polymers. In another example, the adhesive compositions can include one or more styrene-butadiene rubber latexes, one or more acrylic polymers, and water. In another example, the adhesive compositions can include one or more styrene-butadiene rubber latexes, one or more tackifier agents, and oil. In another example, the adhesive compositions can include one or more styrene-butadiene rubber latexes, one or more tackifier agents, oil and water. In another example, the adhesive compositions can include one or more styrene-butadiene rubbers and one or more ethylene propylene diene monomer rubbers. In another example, the adhesive compositions can include one or more styrene-butadiene rubbers, one or more ethylene propylene diene monomer rubbers, and water.

The adhesive compositions can have a low volatile organic compound pressure and have high peel strength and loop tack on both low and high surface energy substrates. In an embodiment, the adhesive compositions can have a higher peel, loop tack, and static shear than noncarboxylated styrene-butadiene rubber adhesives tested in the prior art (U.S. Pat. No. 4,189,419), and even some formulated carboxylated styrene-butadiene rubber adhesives. In addition, mixing with a bladeless speed mixer can save more energy and time compared to high shear mixer.

The concentration of the one or more styrene-butadiene rubbers in the adhesive compositions can vary widely. For example, the adhesive compositions can have a concentration of the one or more styrene-butadiene rubbers from a low of about 5 wt %, about 10 wt %, or about 30 wt %, to a high of about 70 wt %, about 80 wt %, or about 95 wt %. For example, the adhesive compositions can have a concentration of the one or more styrene-butadiene rubbers from about 5 wt % to about 95 wt %, about 25 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 20 wt % to 30 wt %, about 50 wt % to about 60 wt %, or about 70 wt % to about 80 wt %. The weight percent of the one or more styrene-butadiene rubbers in the adhesive compositions can be based on the total weight of the total adhesive composition; based on the total weight of the one or more styrene-butadiene rubbers, one or more tackifier agents, one or more acrylic polymers, one or more ethylene propylene diene monomer rubbers, one or more oils, one or more additives, and water; based on the total weight of the one or more styrene-butadiene rubbers and one or more tackifier agents; based on the total weight of the one or more styrene-butadiene rubbers and one or more acrylic polymers; based on the total weight of the one or more styrene-butadiene rubbers, one or more acrylic polymers, and one or more additives; based on the total weight of the one or more styrene-butadiene rubbers, one or more tackifier agents, and oil; based on the total weight of the one or more styrene-butadiene rubbers, one or more tackifier agents, oil and water; based on the total weight of the one or more styrene-butadiene rubbers and one or more ethylene propylene diene monomer rubbers; based on the total weight of the one or more styrene-butadiene rubbers, one or more ethylene propylene diene monomer rubbers, one or more additives, and water.

The one or more styrene-butadiene rubbers can include one or more styrene-butadiene rubber latexes. The concentration of the one or more styrene-butadiene rubber latexes in the adhesive compositions can vary widely. For example, the adhesive compositions can have a concentration of the one or more one or more styrene-butadiene rubber latexes from a low of about 5 wt %, about 10 wt %, or about 30 wt %, to a high of about 70 wt %, about 80 wt %, or about 95 wt %. For example, the adhesive compositions can have a concentration of the one or more styrene-butadiene rubber latexes from about 5 wt % to about 95 wt %, about 25 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 20 wt % to 30 wt %, about 50 wt % to about 60 wt %, or about 70 wt % to about 80 wt %. The weight percent of the one or more one or more styrene-butadiene rubber latexes in the adhesive compositions can be based on the total weight of the total adhesive composition; based on the total weight of the one or more styrene-butadiene rubber latexes, one or more tackifier agents, one or more acrylic polymers, one or more ethylene propylene diene monomer rubbers, one or more oils, one or more additives, and water; based on the total weight of the one or more styrene-butadiene rubber latexes and one or more tackifier agents; based on the total weight of the one or more styrene-butadiene rubber latexes and one or more acrylic polymers; based on the total weight of the one or more styrene-butadiene rubber latexes and one or more acrylic polymer latex; based on the total weight of the one or more styrene-butadiene rubber latexes, one or more acrylic polymers, and one or more additives; based on the total weight of the one or more styrene-butadiene rubber latexes, one or more tackifier agents, and oil; based on the total weight of the one or more styrene-butadiene rubber latexes, one or more tackifier agents, oil and water; based on the total weight of the one or more styrene-butadiene rubber latexes and one or more ethylene propylene diene monomer rubbers; based on the total weight of the one or more styrene-butadiene rubbers, one or more ethylene propylene diene monomer rubbers, one or more additives, and water.

The concentration of the one or more tackifier agents in the adhesive compositions can vary widely. For example, the adhesive compositions can have a concentration of the one or more tackifier agents from a low of about 0 wt %, about 0.5 wt %, or about 1 wt %, to a high of about 50 wt %, about 70 wt %, or about 90 wt %. For example, the adhesive composition can have a concentration of the one or more tackifier agents from about 0 wt % to about 90 wt %, 1 wt % to about 10 wt %, 0.5 wt % to about 10 wt %, about 2 wt % to about 20 wt %, about 5 wt % to about 60 wt %, about 15 wt % to about 25 wt %, about 19 wt % to about 27 wt %, about 17 wt % to about 29 wt %, about 30 wt % to about 54 wt %, about 33 wt % to about 48 wt %, about 30 wt % to about 40 wt %, about 51 wt % to about 54 wt %, about 20 wt % to 30 wt %, about 50 wt % to about 60 wt %, about 25 wt % to about 75 wt %, about 20 wt % to about 80 wt %, about 20 wt % to about 25 wt %, or about 75 wt % to about 80 wt %. The weight percent of the one or more tackifier agents in the adhesive compositions can be based on the total weight of the total adhesive composition; based on the total weight of the one or more styrene-butadiene rubbers, one or more tackifier agents, one or more acrylic polymers, one or more ethylene propylene diene monomer rubbers, one or more oils, one or more additives, and water; based on the total weight of the one or more styrene-butadiene rubbers and one or more tackifier agents; based on the total weight of the one or more styrene-butadiene rubbers, one or more tackifier agents, and oil; based on the total weight of the one or more styrene-butadiene rubbers, one or more tackifier agents, one or more additives, and oil; based on the total weight of the one or more styrene-butadiene rubbers, one or more tackifier agents, and one or more ethylene propylene diene monomer rubbers; based on the total weight of the one or more styrene-butadiene rubbers, one or more tackifier agents, one or more ethylene propylene diene monomer rubbers, and one or more additives.

The concentration of the one or more acrylic polymers in the adhesive compositions can vary widely. For example, the adhesive compositions can have a concentration of the one or more acrylic polymers from a low of about 0 wt %, about 0.5 wt %, or about 1 wt %, to a high of about 50 wt %, about 70 wt %, or about 90 wt %. For example, the adhesive compositions can have a concentration of the one or more acrylic polymers from about 0 wt % to about 90 wt %, 0 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 19 wt % to about 27 wt %, about 15 wt % to about 27 wt %, about 14 wt % to about 24 wt %, about 11 wt % to about 28 wt %, about 33 wt % to about 48 wt %, about 51 wt % to about 54 wt %, or about 50 wt % to about 60 wt %. The weight percent of the one or more acrylic polymers in the adhesive compositions can be based on the total weight of the total adhesive composition; based on the total weight of the one or more styrene-butadiene rubbers, one or more tackifier agents, one or more acrylic polymers, one or more ethylene propylene diene monomer rubbers, one or more oils, one or more additives, and water; based on the total weight of the one or more styrene-butadiene rubbers and one or more acrylic polymers; based on the total weight of the one or more styrene-butadiene rubbers, one or more acrylic polymers, and one or more additives; based on the total weight of the one or more styrene-butadiene rubbers, one or more tackifier agents, and oil; based on the total weight of the one or more styrene-butadiene rubbers, one or more acrylic polymers, one or more additives, and oil; based on the total weight of the one or more styrene-butadiene rubbers, one or more acrylic polymers, and one or more ethylene propylene diene monomer rubbers; based on the total weight of the one or more styrene-butadiene rubbers, one or more acrylic polymers, one or more ethylene propylene diene monomer rubbers, and one or more additives.

The one or more acrylic polymers can include one or more one or more acrylic polymer latexes. The concentration of the one or more acrylic polymer latexes in the adhesive compositions can vary widely. For example, the adhesive compositions can have a concentration of the one or more acrylic polymer latexes from a low of about 0 wt %, about 0.5 wt %, or about 1 wt %, to a high of about 50 wt %, about 70 wt %, or about 90 wt %. For example, the adhesive compositions can have a concentration of the acrylic polymer latexes from about 0 wt % to about 90 wt %, 0 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 19 wt % to about 27 wt %, about 15 wt % to about 27 wt %, about 14 wt % to about 24 wt %, about 11 wt % to about 28 wt %, about 33 wt % to about 48 wt %, about 51 wt % to about 54 wt %, or about 50 wt % to about 60 wt %. The weight percent of the one or more acrylic polymer latexes in the adhesive compositions can be based on the total weight of the total adhesive composition; based on the total weight of the one or more styrene-butadiene rubbers, one or more tackifier agents, one or more acrylic polymer latexes, one or more ethylene propylene diene monomer rubbers, one or more oils, one or more additives, and water; based on the total weight of the one or more styrene-butadiene rubbers and one or more acrylic polymer latexes; based on the total weight of the one or more styrene-butadiene rubbers latexes and one or more acrylic polymer latexes; based on the total weight of the one or more styrene-butadiene rubbers, one or more acrylic polymers, and one or more additives; based on the total weight of the one or more styrene-butadiene rubbers, one or more tackifier agents, and oil; based on the total weight of the one or more styrene-butadiene rubbers, one or more acrylic polymers, one or more additives, and oil; based on the total weight of the one or more styrene-butadiene rubbers, one or more acrylic polymers, and one or more ethylene propylene diene monomer rubbers; based on the total weight of the one or more styrene-butadiene rubbers, one or more acrylic polymers, one or more ethylene propylene diene monomer rubbers, and one or more additives.

The concentration of the one or more ethylene propylene diene monomer rubbers in the adhesive compositions can vary widely. For example, the adhesive compositions can have a concentration of the one or more ethylene propylene diene monomer rubbers from a low of about 0.0 wt %, about 0.5 wt %, or about 1 wt %, to a high of about 50 wt %, about 70 wt %, or about 90 wt %. For example, the adhesive composition can have a concentration of the one or more ethylene propylene diene monomer rubbers from about 0.0 wt % to about 90 wt %, 0 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 30 wt % to about 54 wt %, about 33 wt % to about 48 wt %, about 51 wt % to about 54 wt %, or about 50 wt % to about 60 wt %. The weight percent of the one or more acrylic polymers in the adhesive compositions can be based on the total weight of the total adhesive composition; based on the total weight of the one or more styrene-butadiene rubbers, one or more tackifier agents, one or more acrylic polymers, one or more ethylene propylene diene monomer rubbers, one or more oils, and water; based on the total weight of the one or more styrene-butadiene rubbers, one or more ethylene propylene diene monomer rubbers, and one or more acrylic polymers; based on the total weight of the one or more styrene-butadiene rubbers, one or more acrylic polymers, and one or more ethylene propylene diene monomer rubbers; based on the total weight of the one or more styrene-butadiene rubbers, one or more ethylene propylene diene monomer rubbers, and oil; based on the total weight of the one or more styrene-butadiene rubbers, one or more acrylic polymers, and one or more ethylene propylene diene monomer rubbers; based on the total weight of the one or more styrene-butadiene rubbers, one or more acrylic polymers, one or more ethylene propylene diene monomer rubbers, and water.

The one or more ethylene propylene diene monomer rubbers can include one or more one or more one or more ethylene propylene diene monomer rubbers latexes. The concentration of the one or more ethylene propylene diene monomer rubbers latexes in the adhesive compositions can vary widely. For example, the adhesive compositions can have a concentration of the one or more ethylene propylene diene monomer rubbers latexes from a low of about 0.0 wt %, about 0.5 wt %, or about 1 wt %, to a high of about 50 wt %, about 70 wt %, or about 90 wt %. For example, the adhesive composition can have a concentration of the one or more ethylene propylene diene monomer rubbers latexes from about 0.0 wt % to about 90 wt %, 0 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 30 wt % to about 54 wt %, about 33 wt % to about 48 wt %, about 51 wt % to about 54 wt %, or about 50 wt % to about 60 wt %. The weight percent of the one or more acrylic polymers in the adhesive compositions can be based on the total weight of the total adhesive composition; based on the total weight of the one or more styrene-butadiene rubbers, one or more tackifier agents, one or more acrylic polymers, one or more ethylene propylene diene monomer rubbers latexes, one or more oils, and water; based on the total weight of the one or more styrene-butadiene rubbers, one or more ethylene propylene diene monomer rubbers latexes, and one or more acrylic polymers; based on the total weight of the one or more styrene-butadiene rubbers, one or more acrylic polymers, and one or more ethylene propylene diene monomer rubbers latexes; based on the total weight of the one or more styrene-butadiene rubber latexes, one or more acrylic polymer latexes, and one or more ethylene propylene diene monomer rubbers latexes; based on the total weight of the one or more styrene-butadiene rubbers, one or more ethylene propylene diene monomer rubbers, and oil; based on the total weight of the one or more styrene-butadiene rubbers, one or more acrylic polymers, and one or more ethylene propylene diene monomer rubbers; based on the total weight of the one or more styrene-butadiene rubbers, one or more acrylic polymers, one or more ethylene propylene diene monomer rubbers, and water.

The concentration of the one or more oils in the adhesive compositions can vary widely. For example, the adhesive compositions can have a concentration of the one or more oils from a low of about 0 wt %, about 0.5 wt %, or about 1 wt %, to a high of about 50 wt %, about 70 wt %, or about 90 wt %. For example, the adhesive compositions can have a concentration of the one or more oils from about 0 wt % to about 90 wt %, 0 wt % to about 10 wt %, about 1 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 30 wt % to about 54 wt %, about 33 wt % to about 48 wt %, about 51 wt % to about 54 wt %, or about 50 wt % to about 60 wt %. The weight percent of the one or more acrylic polymers in the adhesive compositions can be based on the total weight of the total adhesive composition; based on the total weight of the one or more styrene-butadiene rubbers, one or more tackifier agents, one or more acrylic polymers, one or more ethylene propylene diene monomer rubbers, one or more oils, and water; based on the total weight of the one or more styrene-butadiene rubbers, one or more tackifier agents, and oil; based on the total weight of the one or more styrene-butadiene rubbers, one or more acrylic polymers, oil and water; based on the total weight of the one or more styrene-butadiene rubbers latexes, one or more acrylic polymers latexes, and oil; based on the total weight of the one or more styrene-butadiene rubbers latexes, one or more acrylic polymers latexes, oil and water; based on the total weight of the one or more styrene-butadiene rubbers, one or more acrylic polymers, and one or more ethylene propylene diene monomer rubbers and oil.

The content or concentration of the one or more additives in the adhesive compositions can vary widely. For example, the adhesive compositions can have a concentration of the one or more additives from a low of about 0 wt %, about 0.5 wt %, or about 1 wt %, to a high of about 50 wt %, about 70 wt %, or about 90 wt %. In another example, the adhesive compositions can have a concentration of the one or more additives of less than 5 wt %, less than 2 wt %, or less than 1 wt %. In another example, the adhesive compositions can have a concentration of the one or more additives from about 0 wt % to about 90 wt %, 0 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 30 wt % to about 54 wt %, about 33 wt % to about 48 wt %, about 51 wt % to about 54 wt %, or about 50 wt % to about 60 wt %. The weight percent of the one or more additives in the adhesive compositions can be based on the total weight of the total adhesive composition; based on the total weight of the one or more styrene-butadiene rubbers, one or more tackifier agents, one or more acrylic polymers, one or more ethylene propylene diene monomer rubbers, one or more oils, one or more additives, and water; based on the total weight of the one or more styrene-butadiene rubbers, one or more tackifiers, one or more additives, and water; based on the total weight of the one or more styrene-butadiene rubbers, one or more acrylic polymers, and one or more additives; based on the total weight of the one or more styrene-butadiene rubbers, one or more ethylene propylene diene monomer rubbers, and one or more additives; based on the total weight of the one or more styrene-butadiene rubbers, one or more acrylic polymers, one or more ethylene propylene diene monomer rubbers, and one or more additives; based on the total weight of the one or more styrene-butadiene rubbers, one or more acrylic polymers, one or more ethylene propylene diene monomer rubbers, oil, one or more additives and water.

The water content or concentration of water in the adhesive compositions can vary widely. For example, the adhesive compositions can have a concentration of the water from a low of about 0 wt %, about 0.5 wt %, or about 1 wt %, to a high of about 50 wt %, about 70 wt %, or about 90 wt %. In another example, the adhesive compositions can have a concentration of the water of less than 5 wt %, less than 2 wt %, or less than 1 wt %. In another example, the adhesive compositions can have a concentration of the water from about 0 wt % to about 90 wt %, 0 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 30 wt % to about 54 wt %, about 33 wt % to about 48 wt %, about 51 wt % to about 54 wt %, or about 50 wt % to about 60 wt %. In another example, the adhesive compositions can be free of water. The weight percent of the water in the adhesive compositions can be based on the total weight of the total adhesive composition; based on the total weight of the one or more styrene-butadiene rubbers, one or more tackifier agents, one or more acrylic polymers, one or more ethylene propylene diene monomer rubbers, one or more oils, and water; based on the total weight of the one or more styrene-butadiene rubbers, one or more tackifiers, and water; based on the total weight of the one or more styrene-butadiene rubbers, one or more acrylic polymers, and water; based on the total weight of the one or more styrene-butadiene rubbers, one or more ethylene propylene diene monomer rubbers, and water; based on the total weight of the one or more styrene-butadiene rubbers, one or more acrylic polymers, one or more ethylene propylene diene monomer rubbers, and water; based on the total weight of the one or more styrene-butadiene rubbers, one or more acrylic polymers, one or more ethylene propylene diene monomer rubbers, oil, and water. The water can be provided as water alone or it can be by the one or more acrylic polymers, which can be in the form of an aqueous dispersion, latex, and/or aqueous emulsion.

The adhesive compositions can have a widely varying solids content. For example, the adhesive compositions can have a solids content from a low of about about 5 wt %, about 10 wt %, or about 30 wt %, to a high of about 70 wt %, about 80 wt %, or about 95 wt %. In another example, the adhesive compositions can have a solids content greater than about 50 wt %, about 55 wt %, or about 70 wt %. In another example, the adhesive compositions can have a solids content from about 5 wt % to about 95 wt %, about 20 wt % to about 70 wt %, about 40 wt % to about 60 wt %, about 45 wt % to about 55 wt %, about 47 wt % to about 54 wt %, about 30 wt % to about 54 wt %, about 33 wt % to about 48 wt %, about 51 wt % to about 54 wt %, or about 50 wt % to about 60 wt %. The weight percent of the solids content of adhesive compositions can be based on the total weight of the adhesive composition, based on the total weight of the one or more polymers and the one or more tackifier agents, based on the total weight of the one or more polymers, the one or more tackifier agents, and the one or more oils, or based on the total weight of the one or more polymers, the one or more tackifier agents, the one or more oils, and water.

The adhesive compositions can have a loop tack that varies widely. For example, the adhesive composition can have a loop tack from a low of about 0.01 lb/in, about 0.05 lb/in, or about 0.1 lb/in, to a high of about 2.0 lb/in, about 3.0 lb/in, or about 5.0 lb/in. In another example, the adhesive compositions can have a loop tack from about 0.01 lb/in to about 3.0 lb/in, about 0.01 lb/in to about 0.1 lb/in, about 0.05 lb/in to about 1.0 lb/in, about 0.10 lb/in to about 0.90 lb/in, about 1.0 lb/in to about 2.0 lb/in, about 1.1 lb/in to about 1.9 lb/in, about 0.50 lb/in to about 1.5 lb/in, and about 0.20 lb/in to about 1.9 lb/in. The loop tack of the adhesive compositions can be measured according to ASTM D6195 on stainless steel, polypropylene, and low-density polyethylene substrates.

The adhesive compositions can have a lap shear that varies widely. For example, the adhesive compositions can have a lap shear from a low of about 1.0 psi, about 2.0 psi, or about 5.0 psi, to a high of about 15.0 psi, about 28.0 psi, or about 38.0 psi. In another example, the adhesive compositions can have a loop tack from about 1.0 psi to about 36.0 psi, about 5.0 psi to about 20.0 psi, about 10.0 psi to about 30.0 psi, about 9.0 psi to about 28.0 psi, about 13.0 psi to about 29.0 psi, about 17.0 psi to about 32.0 psi, and about 1.0 psi to about 31.0 psi. The lap shear of the adhesive composition can be measured according to ASTM D 1002 on aluminum and polypropylene substrate panels.

The one or more styrene-butadiene rubbers can have styrene weight percent to butadiene weight percent that can vary widely. For example, one or more styrene-butadiene rubbers can have a styrene content from about 20 wt % to about 25 wt % and a butadiene content from about 75 wt % to about 80 wt %. In another example, the one or more styrene-butadiene rubbers can have a styrene content from about 18 wt % to about 30 wt % and a butadiene content from about 70 wt % to about 82 wt %. In another example, the one or more styrene-butadiene rubbers can have about 23.5 wt % of styrene and about 76.5 wt %. In another example, the mole percent styrene can be about 13.8% and the mole percent butadiene can be about 86.2%.

The one or more styrene-butadiene rubbers can have weight average molecular weight that can vary widely. For example, the one or more styrene-butadiene rubbers can have a weight average molecular weight from a low of about 300,000 Daltons, about 350,000 Daltons, or about 400,000 Daltons, to a high of about 475,000 Daltons, about 500,000 Daltons, or about 600,000 Daltons. In another example, the one or more styrene-butadiene rubbers can have a weight average molecular weight from about 300,000 Daltons to about 350,000 Daltons, about 350,000 Daltons to about 450,000 Daltons, about 400,000 Daltons to about 430,000, Daltons about 400,000 Daltons to about 600,000 Daltons.

The one or more styrene-butadiene rubbers can have a molecular weight distribution (Mw/Mn) from a low of about 3.0, about 4.0, or about 5.0, to a high of about 6.0, about 7.0, or about 10. For example, one or more styrene-butadiene rubbers can have a molecular weight distribution (Mw/Mn) from about 3.0 to about 9.0, about 5.0 to about 6.0, or about 4.0 to about 7.0. In another example, the one or more styrene-butadiene rubbers can have a molecular weight distribution (Mw/Mn) of about 5.9.

The one or more styrene-butadiene rubbers that are crosslinked can have a viscosity that can vary widely. For example, the one or more styrene-butadiene rubbers that are crosslinked can have a viscosity from a low of about 5,000 cP, about 5,500 cP, or about 6,000 cP, to a high of about 8,000 cP, to about 9,000 cP, or about 10,000 cP. In another example, the one or more styrene-butadiene rubbers that are crosslinked can have a viscosity from about 7,200 cP to about 7,387 cP, about 6,200 cP to about 8,500 cP, about 7,387 cP to about 7,500 cP, about 7,000 cP to about 8,000 cP, about 6,500 cP to about 8,550 cP, about 7,000 cP to about 8,000 cP, about 5,000 cP to about 10,000 cP.

The one or more styrene-butadiene rubbers that are non-crosslinked can have a viscosity that can vary widely. For example, the one or more styrene-butadiene rubbers that are non-crosslinked can have a viscosity from a low of about 3,000 cP, 4,000 cP to about 5,000 cP, about 3,500 cP, or about 4,000 cP, to a high of about 6,000 cP, to about 7,000 cP, or about 9,000 cP. In another example, the one or more styrene-butadiene rubbers that are non-crosslinked can have a viscosity from about 3,200 cP to about 4,800 cP, about 4,800 cP to about 5,500 cP, about 4,500 cP to about 5,550 cP, about 5,000 cP to about 6,000 cP, about 4,000 cP to about 9,000 cP.

The one or more styrene-butadiene rubbers can be provided in various forms. For example, the one or more styrene-butadiene rubbers can be provided as a waterborne polymer, a resin, an emulsion, a dispersion, a colloidal suspension, a gel, a latex, a rubber, or a rubber latex. In another example, the one or more styrene-butadiene rubbers can be provided as a stable dispersion and/or emulsion of styrene-butadiene polymer microparticles in water. The one or more latexes and one or more styrene-butadiene rubbers can be crosslinked, non-crosslinked, or a mixture of crosslinked and non-crosslinked. The styrene-butadiene rubber can include a carboxylated and/or a non-carboxylated styrene-butadiene rubber.

The one or more styrene-butadiene rubbers can have a widely varying solids content. For example, the one or more styrene-butadiene rubbers can have a solids content from a low of about about 5 wt %, about 10 wt %, or about 30 wt %, to a high of about 70 wt %, about 80 wt %, or about 95 wt %. In another example, the one or more styrene-butadiene rubbers can have a solids content of greater than about 50 wt %, greater than about 60 wt %, less than greater than about 60 wt %, or less than 7about 0 wt %. In another example, the one or more styrene-butadiene rubbers can have a solids content from about 5 wt % to about 95 wt %, about 20 wt % to about 70 wt %, about 40 wt % to about 60 wt %, about 45 wt % to about 55 wt %, about 47 wt % to about 54 wt %, about 30 wt % to about 54 wt %, about 33 wt % to about 48 wt %, about 51 wt % to about 54 wt %, or about 50 wt % to about 60 wt %. The weight percent of the solids content of one or more styrene-butadiene rubbers can be based on the total weight of the one or more styrene-butadiene rubbers or based on the total weight of the one or more styrene-butadiene rubbers and water.

The one or more tackifier agents can include, but is not limited to, a rosin ester, a hydrocarbon, rosin acid, terpene, modified terpene, coumarone-indene, or a combination thereof. Commercially available tackifiers can include, but are not limited to, TACOLYN® 3400 and TACOLYN® 1070.

In one or more embodiments, the tackifier may be replaced by or supplemented by an acrylic polymer. Commercially available acrylic polymers that can be used, can include, but are not limited to, Henkel's AQUENCE® acrylic emulsions, Dow Chemical's ROBOND™ acrylic emulsions, or Franklin International Covinax acrylic emulsion.

The one or more acrylic polymers can be provided in various forms. For example, the one or more acrylic polymers can be provided as a waterborne polymer, a resin, an emulsion, a dispersion, a colloidal suspension, a gel, a latex, a rubber, or a rubber latex. In another example, the one or more acrylic polymers can be provided as a stable dispersion and/or emulsion of styrene-butadiene polymer microparticles in water. The one or more acrylic polymers can be crosslinked, non-crosslinked, or a mixture of crosslinked and non-crosslinked.

The one or more acrylic polymers can have a widely varying solids content. For example, the one or more acrylic polymers can have a solids content from a low of about about 5 wt %, about 10 wt %, or about 30 wt %, to a high of about 70 wt %, about 80 wt %, or about 95 wt %. In another example, the one or more acrylic polymers can have a solids content from about 5 wt % to about 95 wt %, about 20 wt % to about 70 wt %, about 40 wt % to about 60 wt %, about 45 wt % to about 55 wt %, about 47 wt % to about 54 wt %, about 30 wt % to about 54 wt %, about 33 wt % to about 48 wt %, about 51 wt % to about 54 wt %, or about 50 wt % to about 60 wt %. The weight percent of the solids content of one or more acrylic polymers can be based on the total weight of the one or more acrylic polymers or based on the total weight of the acrylic polymer and water.

The one or more ethylene propylene diene monomer rubbers can include a liquid ethylene propylene diene monomer rubber (EPDM). Commercially available ethylene propylene diene monomer rubber can include, but is not limited to, TRILENE® sold by LION ELASTOMERS®.

The one or more ethylene propylene diene monomer rubbers can be provided in various forms. For example, the one or more ethylene propylene diene monomer rubbers can be provided as a waterborne polymer, a resin, an emulsion, a dispersion, a colloidal suspension, a gel, a latex, a rubber, or a rubber latex. In another example, the one or more ethylene propylene diene monomer rubbers can be provided as a stable dispersion and/or emulsion of ethylene propylene diene monomer rubbers microparticles in water. The ethylene propylene diene monomer rubbers can be crosslinked, non-crosslinked, or a mixture of crosslinked and non-crosslinked.

The one or more ethylene propylene diene monomer rubbers can have a widely varying solids content. For example, the one or more ethylene propylene diene monomer rubbers can have a solids content from a low of about about 5 wt %, about 10 wt %, or about 30 wt %, to a high of about 70 wt %, about 80 wt %, or about 95 wt %. In another example, the one or more ethylene propylene diene monomer rubbers can have a solids content from about 5 wt % to about 95 wt %, about 20 wt % to about 70 wt %, about 40 wt % to about 60 wt %, about 45 wt % to about 55 wt %, about 47 wt % to about 54 wt %, about 30 wt % to about 54 wt %, about 33 wt % to about 48 wt %, about 51 wt % to about 54 wt %, or about 50 wt % to about 60 wt %. The weight percent of the solids content of one or more ethylene propylene diene monomer rubbers can be based on the total weight of the one or more one or more ethylene propylene diene monomer rubbers or based on the total weight of the one or more ethylene propylene diene monomer rubbers and water.

The one or more ethylene propylene diene monomer rubbers can have a Mooney viscosity that varies widely. For example, the one or more ethylene propylene diene monomer rubbers can have Mooney viscosity ML (1+4) at 125° C. from a low of about 35 MU, about 40 MU, or about 45 MU, to a high of about 55 MU, about 65 MU, or about 85 MU. In another example, the one or more ethylene propylene diene monomer rubbers can have Mooney viscosity ML (1+4) at 125° C. from about 35 MU to about 75 MU, about 40 MU to about 55 MU, about 39 MU to about 65 MU, about 40 MU to about 50 MU, and about 38 MU to about 65 MU

The one or more oils can include, mineral oil, naphthenic oil, paraffin oil, aromatic oil, or a combination thereof. Commercially available oils that can be used, can include, but are not limited to, IRM 903 oil.

One or more additives can include, but are not limited to, wetting agents, surfactants, pigments, opacifying agents, anti-foam agents, water, and mixtures thereof

In one embodiment, the adhesive composition can be prepared by mixing concentrated hot styrene-butadiene rubber latex, preferably with over 50% solid by weight, and rosin ester tackifier or acrylic polymer latex. Tackifier or acrylic latex were mixed with SBR latex with bladeless mixer for a set time to allow thorough mixing. Thereafter, the water can be at least partially removed from the adhesive composition. In another embodiment, the one or more polymer can be a waterborne polymer that can be mixed with one or more tackifier agents. The water provided from the waterborne polymer can then be removed from the composition.

In an embodiment, the one or more polymers and one or more tackifier agent, and/or one or more oils and/or water can be mechanically blended, combined, and/or mixed. The adhesive composition can be blended by a speed mixer process which may or may not employ blades. The mixture can be mixed using a bladeless speed mixer until thoroughly mixed. In one or more embodiments, the adhesive composition can be at least partially dehydrated after mixing.

In an embodiment, the adhesive composition can be prepared by mixing concentrated hot styrene-butadiene rubber latex, preferably with over 50% solid by weight, and rosin ester tackifier or acrylic polymers. Tackifier or acrylic polymers can be mixed with SBR latex with bladeless mixer for a set time to allow thorough mixing. Thereafter, the water can be at least partially removed.

In one or more embodiments, the adhesive can be applied on substrate with surface energy lower than 35 mJ/m².

The instant embodiment is formed with a waterborne hot polymerized styrene-butadiene rubber. By using a 50+% solids hot polymerized styrene-butadiene rubber for adhesive applications, the instant embodiment provides manufacturers with the “hot” performance advantages compared to existing SBR latexes, providing the capability for manufactures to take advantage of the performance benefits provided thereby in low or even no VOC waterborne adhesives. The typical properties for hot styrene-butadiene rubber latexes types are set forth in the table below, comparing crosslinked to non-crosslinked applications:

TABLE 1
Comparative Properties of Crosslinked and Non-crosslinked Hot SBR Latexes

| | Hot Styrene-Butadiene Rubber Type | |
|---|---|---|
| | | Non- |
| | Crosslinked | crosslinked |
| Hot SBR | SBR 201 | SBR 101 |
| Solid content, % | 50-53 | 50-53 |
| PH | 10.5 | 10.50 |
| Density, g/cm3 | 0.97 | 0.97 |
| Viscosity, cP | 7,387 | 4,800 |
| Shelf life month | 6+ months | 6+ months |
| Surfactant type | Fatty acid | Rosin acid |
| Hardness Shore A (from cast film) | 27.9 | 24.5 |
| Elongation, % (from cast film) | 124 | 176 |
| T_{g}, C. (from cast film) | −54 | −55 |
| Static shear, 1 kg load, 3 d conditioning, | 246 | 34 |
| 1 day dwell, 0.25 in2, min | | |
| Lap shear on stainless steel, 3 d | 22.5 | 21.1 |
| conditioning, 1 day dwell, 0.25 in2, psi | | |
| Lap shear on glass, 3 d conditioning, 1 | 23.0 | 21.8 |
| day dwell, 0.25 in2, psi | | |
| Lap shear on aluminum, 3 d conditioning, | 23.4 | 19.4 |
| 1 day dwell, 0.25 in2, psi | | |
| Lap shear on polypropylene, 3 d conditioning, | 20.6 | 16.1 |
| 1 day dwell, 0.25 in2, psi | | |

### EXAMPLES

To provide a better understanding of the foregoing discussion, the following non-limiting examples are offered. Although the examples can be directed to specific embodiments, they are not to be viewed as limiting the invention in any specific respect.

Sample preparation: Hot SBR latex and rosin ester tackifier or acrylic polymer were mixed by Speed Mixer at 800 rpm for 10 min. Adhesive films having 22±2 g/m² dry weight were prepared on PET mylar with wire bar applicator. ROBOND™ acrylic emulsion was tested as reference example in this patent. Wet film was pre-dried at ambient temperature for 10 min, then dried in lab oven with 120° C. for 10 min. Dried films were covered by release papers and conditioned in a dark environment at ambient temperature (23° C.) and a relative humidity of 50% for 3 days before testing.

Testing methods: High surface energy substrates tested in this invention were aluminum and stainless steel with 840 and 900 mJ/m² surface energy, and low surface energy substrates were LDPE and PP with 31 and 29 mJ/m² surface energy.

Loop tack was conducted according to ASTM D6195. 7×1 inch² (178×25 mm²) specimen strips were cut from conditioned film and inserted into grips of tensile tester. Minimum and maximum gap between the bottom of upper grips and face of substrate were 25 mm and 100 mm, respectively. Substrate panels were stainless steel (SS), polypropylene (PP) and low-density polyethylene (LDPE). Crosshead speed was 300 mm/min. Testing was conducted at ambient temperature (23° C.) and a relative humidity of 50%. Maximum force needed to separate the adhesive from substrate panels was recorded as pounds per inch width. Three strips were tested for each formula.

The peel test was conducted according to PSTC-101. For the peel test, twenty-five 275 mm specimen strips were cut from conditioned film, and 6×1 inch² (152×25 mm²) of strips were applied on substrate panels by roller at 300 mm/min for 2 cycles. Adhesive joint samples were dwelled ambient temperature (23° C.) and a relative humidity of 50% for 1 day before testing. Substrate panels were stainless steel (SS), polypropylene (PP) and low-density polyethylene (LDPE). Samples were placed on an Adhesion/Release Tester, and the free end of strips were double backed and clamped at an angle of 180°. Strips were peeled off from substrate at 300 mm/min. Averaged pull values of 2 inches of applied area were recorded as pounds per inch width. The peel test was conducted at ambient temperature (23° C.) and a relative humidity of 50%.

A static shear test with 500 g loading was conducted according to PSTC-107. 6*0.5 inch² (152*13 mm²) specimen strips were cut from conditioned film, and 0.5*0.5 inch² (13*13 mm²) strips were applied on stainless steel panels by roller at 300 mm/min for 2 cycles. Adhesive joint samples were conditioned at ambient temperature (23° C.) and a relative humidity of 50% for 1 day before testing. Clamps were secured on the free end of strips by 2 staples. Samples were placed in the test stand and clamps were at vertical position. 500 g loadings were applied to clamps after timer started. The time elapsed until strips separated from stainless steel panel was recorded. Test was conducted at ambient temperature (23° C.) and a relative humidity of 50%.

A Static shear test with 100 g loading was also conducted with same adhesive joint samples prepared in static shear test with 500 g loading. Samples were conditioned at ambient temperature (23° C.) and a relative humidity of 50% for 3 min before 100 g loading were applied to clamps. Test was conducted at 100° C. and a relative humidity of 50%. The time elapsed until the strips separated from stainless steel panel was recorded. The test was conducted at ambient temperature (23° C.) and a relative humidity of 50%.

A lap shear test was conducted according to ASTM D 1002. Adhesive joint samples were prepared with the same method as those in the static shear test. Substrate panels were aluminum and polypropylene. Panels and free end of strips were fixed by grips of tensile tester. Crosshead speed was 300 mm/min. Load at failure was recorded as pounds per inch width.

The glass transition temperature, T_{g}, was measured by temperature sweep tests with 2.5 ° C./min, 10 rad/s frequency and 0.3% strain. The T_{g} describes the temperature region where the mechanical properties of the materials change from hard and brittle to more soft, deformable or rubbery. Temperature where tan delta reached maximum value was recorded as T_{g}. The results of the test are provided in Table 2 below.

Groups A, B, and C were pressure sensitive adhesive of the present invention, while groups D, E, F, and G were reference groups of commercial acrylic adhesives for applications on low surface energy substrate in Table 2. Group A had higher peel strength on polypropylene and stainless steel, and group C had higher static shear and lap shear, compared to all reference groups. Group B had higher loop tack on polypropylene than reference groups D, E, and F. T_{g} of groups A and B was lower than Groups D, F, and G which indicated the pressure sensitive adhesive had better low-temperature resistance than some acrylic emulsions.

TABLE 2
Test Results of SBR and Acrylic Adhesives.

| Groups | A | B | C | D | E | F | G |
|---|---|---|---|---|---|---|---|
| SBR 101, g | 27 | 10 | 30 | 0 | 0 | 0 | 0 |
| Acrylic emulsion A, g | 0 | 30 | 0 | 40 | 0 | 0 | 0 |
| Acrylic emulsion B, g | 0 | 0 | 0 | 0 | 40 | 0 | 0 |
| Acrylic emulsion C, g | 0 | 0 | 10 | 0 | 0 | 40 | 0 |
| ROBOND ™ PS-8537, g | 0 | 0 | 0 | 0 | 0 | 0 | 40 |
| TACOLYN ® 3570, | 13 | 0 | 0 | 0 | 0 | 0 | 0 |
| Rosin Ester, g | | | | | | | |

Adhesive Performance Properties

| | | | | | | | |
|---|---|---|---|---|---|---|---|
| Loop Tack on stainless | 1.44 | 2.44 | 1.11 | 3.40 | 2.00 | 2.00 | 3.48 |
| steel, lb/in | | | | | | | |
| Loop Tack on PP, lb/in | 2.23 | 3.63 | 2.37 | 3.22 | 3.45 | 3.03 | 6.88 |
| 180° peel on stainless | 6.83 | 4.93 | 4.32 | 4.25 | 2.44 | 3.16 | 4.60 |
| steel, lb/in | | | | | | | |
| 180° peel on PP, lb/in | 5.48 | 4.74 | 4.24 | 4.16 | 2.69 | 4.13 | 4.33 |
| Static shear 500 g, | 298.33 | 276.00 | 3663.33 | 175.33 | 172.00 | 1996.67 | 248.67 |
| room temperature min | | | | | | | |
| Static shear, 100° C. | 60.50 | 25600+ | 18600+ | 70 | 1149 | 15800+ | 98 |
| 100 g, min | | | | | | | |
| lap shear on aluminum, | 15.23 | 16.49 | 37.32 | 14.41 | 15.91 | 36.98 | 21.37 |
| psi | | | | | | | |
| lap shear on PP, psi | 16.78 | 16.10 | 38.77 | 14.99 | 16.24 | 42.79 | 21.32 |
| T_{g},° C. | −29 | −29 | −50 | −25 | −35 | −17 | −22 |
| | | | and −18 | | | | |

Additional testing has been performed at differing concentrations of crosslinked styrene-butadiene rubber, non-crosslinked styrene-butadiene rubber, and combinations thereof. Further tests were also performed under similar operating conditions both with and without the addition of naphthenic oil and hydrocarbon tackifier. The parameters of the adhesive mixtures and results of the tests are set forth in the following tables.

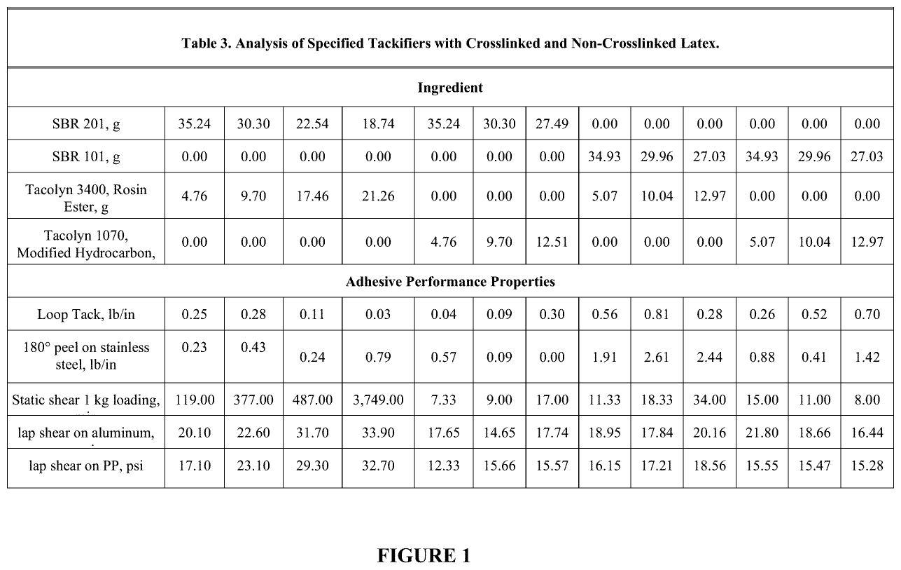

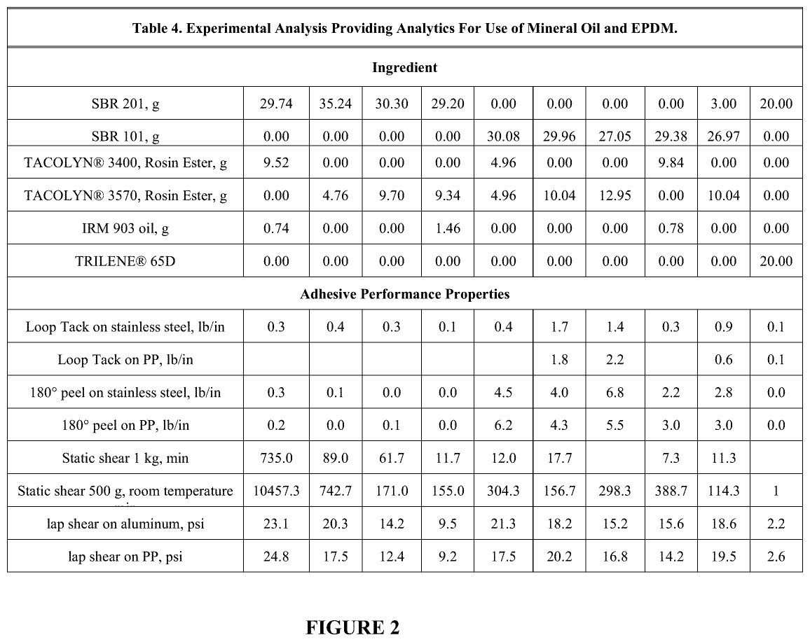

As shown FIGS. 1 and 2, the rosin ester provides a better balance of properties than hydrocarbon tackifier. Additionally, the non-crosslinked hot styrene-butadiene rubber emulsions offers higher peel and loop tack compared to comparable mixtures using crosslinked hot styrene-butadiene rubber emulsions. But, the crosslinked hot styrene-butadiene rubber provides better lap shear on low surface energy substrates such as polypropylene compared to the non-crosslinked hot styrene-butadiene rubber emulsion. Furthermore, the crosslinked hot styrene-butadiene rubber emulsion analysis shows promise to increase the static shear when desired for a particular application.

As shown FIGS. 1 and 2, naphthenic oil can improve static shear of crosslinked SBR. In addition, tackifier with low softening point can further improve loop tack and peel strength of non-crosslinked hot SBR emulsions, as TACOLYN® 3570 had lower softening point than TACOLYN® 3400. SBR emulsion 201 and 101 were miscible with ethylene propylene diene monomer rubber emulsion (TRILENE® 65D), although adhesion properties of the EPDM/crosslinked SBR blend were low.

One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application.

Unless otherwise indicated, all numbers expressing feature sizes, amounts, and physical properties used in the specification and claims are to be understood as being modified in all instances by the term “about.” Accordingly, unless indicated to the contrary, the numbers set forth are approximations that can vary depending upon the desired properties using the teachings disclosed herein.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should a so be appreciated that the numerical limits may be the values from the examples. Certain lower limits, upper limits and ranges appear in at least one claims below. All numerical values are “about” or “approximately” the indicated value, and consider experimental error and variations that would be expected by a person having ordinary skill in the art.

Before explaining the present formulation in detail, it is to be understood that the formulation is not limited to the particular embodiments and that it can be practiced or carried out in various ways.

Although the invention has been described with reference to the above examples, it will be understood that modifications and variations are encompassed within the spirit and scope of the invention. Accordingly, the invention is limited only by the following claims.

What is claimed is:

1. An adhesive composition comprising:
a styrene-butadiene rubber latex, wherein the styrene-butadiene rubber latex is present in a concentration from about 60 wt % to about 70 wt %, based on the total weight of the adhesive composition; and
a tackifier agent, wherein the tackifier agent is present in a concentration from about 30 wt % to about 40 wt %, based on the total weight of the adhesive composition.

2. The adhesive composition of claim 1, wherein the adhesive composition has a loop tack from about 0.01 lb/in to about 3.0 lb/in conducted according to ASTM D6195.

3. The adhesive composition of claim 1, wherein the adhesive composition has a lap shear from about 1 psi to about 36 psi conducted according to ASTM D 1002.

4. The adhesive composition of claim 1, wherein the styrene-butadiene rubber latex has a viscosity from about 4,000 cP to about 5,000 cP.

5. The adhesive composition of claim 1, wherein the styrene-butadiene rubber latex has a viscosity from about 7,000 cP to about 8,000 cP.

6. The adhesive composition of claim 1, wherein the styrene-butadiene rubber latex has a solids content of greater than 50 wt %.

7. The adhesive composition of claim 1, wherein the tackifier is selected from rosin ester tackifier, rosin acid, hydrocarbon, terpene, modified terpene, coumarone-indene, or a combination thereof.

8. The adhesive composition of claim 1, further comprising a mineral oil.

9. The adhesive composition of claim 1, further comprising an ethylene propylene diene monomer rubber.

10. The adhesive composition of claim 5, wherein the styrene-butadiene rubber latex is crosslinked.

11. The adhesive composition of claim 2, wherein the styrene-butadiene rubber latex is selected from a group comprising crosslinked, non-crosslinked, or a combination of crosslinked and non-crosslinked latex.

12. The adhesive composition of claim 2, wherein the tackifier is a rosin ester.

13. An adhesive composition comprising:
a styrene-butadiene rubber latex, wherein the styrene-butadiene rubber latex is present in a concentration from about 20 wt % to about 80 wt %, based on the total weight of the adhesive composition; and
an acrylic polymer, wherein the acrylic polymer is present in a concentration from about 20 wt % to about 80 wt %, based on the total weight of the adhesive composition.

14. The adhesive composition of claim 13, wherein the adhesive composition has a loop tack from about 0.01 lb/in to about 3.0 lb/in conducted according to ASTM D6195.

15. The adhesive composition of claim 13, wherein the adhesive composition has a lap shear from about 1 psi to about 36 psi conducted according to ASTM D 1002.

16. The adhesive composition of claim 13, further comprising a mineral oil.

17. The adhesive composition of claim 13, further comprising an ethylene propylene diene monomer rubber.

18. The adhesive composition of claim 13, wherein the adhesive composition has a solids content of greater than 50 wt %.

19. The adhesive composition of claim 14, wherein the acrylic polymer comprises a latex.

20. An adhesive composition comprising:
a styrene-butadiene rubber latex, wherein the styrene-butadiene rubber latex is present in a concentration from about 60 wt % to about 70 wt %, based on the total weight of the adhesive composition;
a tackifier agent, wherein the tackifier agent is present in a concentration from about 30 wt % to about latex 40 wt %, based on the total weight of the adhesive composition; and
a naphthenic oil, wherein the naphthenic oil is present in a concentration from about 1 wt % to about 10 wt %, based on the total weight of the adhesive composition, wherein the adhesive composition has a loop tack from about 0.01 lb/in to about 3.0 lb/in conducted according to ASTM D6195, and wherein the adhesive composition has a lap shear from about 1 psi to about 36 psi conducted according to ASTM D 1002.
